(19) United States
(12) Patent Application Publication
(10) Pub. No.: US 2021/0325033 A1
(43) Pub. Date: Oct. 21, 2021

(54) Petcup

(71) Applicant: Phillip Eugene Johnwell, Santa Rosa, CA (US)

(72) Inventor: Phillip Eugene Johnwell, Santa Rosa, CA (US)

(21) Appl. No.: 16/974,386

(22) Filed: Jan. 7, 2021

Related U.S. Application Data
(60) Provisional application No. 63/101,100, filed on Apr. 17, 2020.
(60) Provisional application No. 63/103,100, filed on Jul. 20, 2020.

(51) Int. Cl. F21V 33/00; F21S 9/02; A47G 19/22

(52) U.S. Cl. CPC F21V 33/0036; F21S 9/022; A47G 2019/2238; A47G 19/2288; A47G 19/2227

(57) ABSTRACT

Petcup is a new product that works as a thermo beverage cup and turned up-side down works as a portable lamp/worklight. As a hot or cold beverage cup the light can be turned on before you set it on the table giving Petcup a one-of-a-kind look. When not being used as a beverage cup, it's a portable lamp/worklight that's light-weight and can go anywhere. You can twist the top and bottom off to wash or just twist the bottom off to change the batteries. Petcup is the only cup/lamp in the world and the only cup with a dual-use as a portable lamp.

### BRIEF DESCRIPTON TO THE DRAWINGS

FIG. 1 is front view of the Petcup.

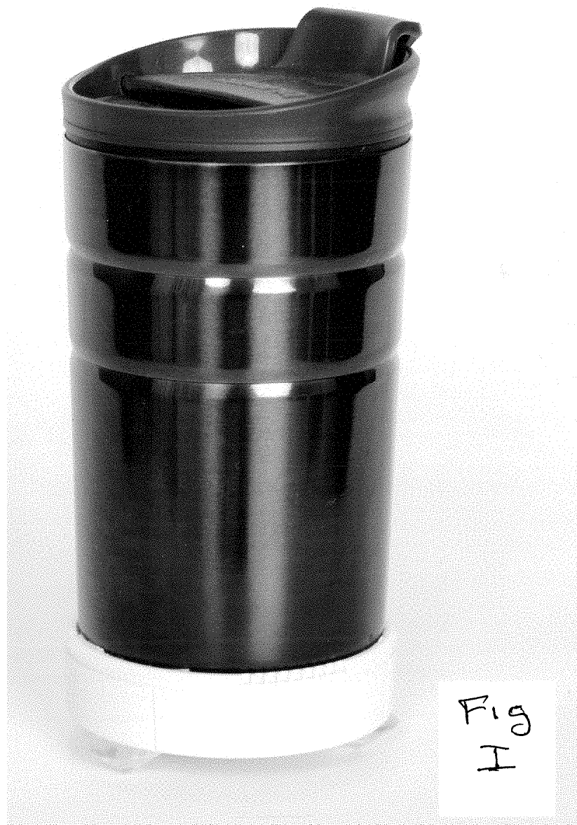

FIG. 2 is a view of the Petcup from a different angle showing the light/lamp part at the bottom of the Cup.

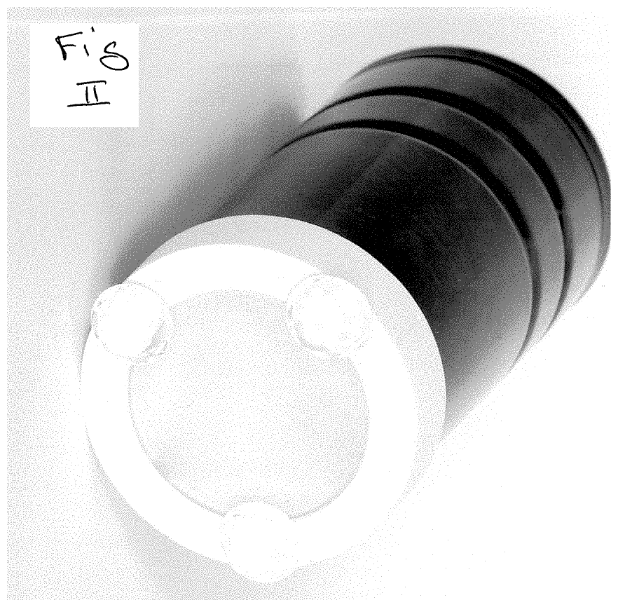

### DETAILED DESCRIPTION OF THE INVENTION

Petcup 1 is a thermos cup that keeps hot drinks hot and cold drinks cold. With the light on it's a unique cup/ornament that nobody has seen before in their life. Petcup 1 has three casters 3 on the bottom, and an adapter 2 for connecting the bottom 4 with the Petcup 1. If you have a cup of coffee and sit down and place this cup on a table with the light on, everybody is going to be looking at this cup because it's different and they have never seen another like it.

If you are 60/70 years old . . . you have never seen Petcup in your life. This is a one of a kind product.

When not being used as a cup, Petcup, when upside down, can be used as a portable lamp and can be used as a portable work light.

By taking the spill proof top off you turn the cup upside down and it works as a portable lamp or a portable work light.

If PG&E turns off the electricity Petcup is a portable emergency lamp. Even your kids know where to find a cup. It's a great portable work light for in the attic or under the kitchen sink. For car troubles at night . . . it's a great portable work light for under the car or under the hood of a car.

Petcup is a good utility light for camping. It's a lamp in a tent as well as a cup. If you are camping you can sure use both of these. It's a thermal cup . . . it's a portable lamp or nightlight . . . it's a portable work light and it's the only one of its kind.

The bottom 4 of the cup can be twisted off to change the batteries.

When the cup is placed on its side, it can also be used as an emergency light. Maybe you get a flat tire at night. Petcup takes the place of a flare.

When placed upside down, Petcup is as a portable lamp . . . for wherever you need a light.

When Petcup is on a countertop with the light at the bottom on, Petcup is a work of art in that it's the only cup of its kind.

Petcup can contain a cold beverage or a hot beverage such as coffee. Regardless what you put in it, it still out shines any other cup. If you are not using Petcup for a beverage, it still can be used for something else . . . a portable lamp, a portable work light . . . an emergency light. No other cup can do that.

1. The following statement is my claim to this invention. My claim is that I invented the first cuplight in the world. No other cup in the world also works as a worklight/lamp and no worklight or lamp in the world also works as a cup.
